(19) United States
(12) Patent Application Publication
(10) Pub. No.: US 2007/0168280 A1
(43) Pub. Date: Jul. 19, 2007

(54) Digital currency

(76) Inventor: John Ko, Moreno Valley, CA (US)

Correspondence Address: Eugene Oak, 16523 Colt Way, Moreno Valley, CA, 92555, US

(21) Appl. No.: 11/332,087

(22) Filed: Jan. 13, 2006

(51) Int. Cl. G06Q 40/00

(52) U.S. Cl. 705/39

(57) ABSTRACT

This novel invention consists of a small, portable electronic device that is used to transfer monetary value in all situations where other forms of money are currently used, including but not limited to: paper money, credit cards, and checks. The electronic device, which is linked to a main server to which all businesses and banks are also connected, is a revolutionary way to make transactions more secure, more convenient, while also serving as a tracking device for the government.

### BACKGROUND OF THE INVENTION

1. Field of the Invention

This invention relates to a portable electronic device that can transfer funds between various sites, such as to and from users, banks, and businesses, without a secondary medium such as cash. It also serves as a tracking device for the government.

2. Description of Prior Art

This is a novel invention.

### SUMMARY OF THE INVENTION

The current invention is a small, portable electronic device that allows the user to transfer funds electronically wherever the user used to use cash, checks, credit cards, or other forms of money using any given user's unique identification number. It is connected to a main server that can be linked to the government to monitor everything, including but not limited to taxes and criminal activity.

The current invention will help prevent most current problems with internet fraud, as well as money used for drugs, prostitution, money laundering, and organized crime, as every dollar will be traceable. Counterfeiting will also be prevented, as will theft and embezzlement. Large corporations, as well as small, will be far more accountable as to where each dollar goes.

The current invention will also make ordinary tasks more convenient. This includes the expedited payment for parking, toll roads, and other similar small expenses that are typically inconvenient when utilizing conventional paper money. Also, it eliminates the need for finding a pen and signing a credit card receipt. It eliminates the need for the millions of paychecks sent every day, and the unnecessary processing by the payroll department and banks.

The current invention will eliminate the waiting time for checks to be processed, as all transactions will be made electronically and balances will be checked on the spot, before the sender is permitted to send funds.

Foreign visitors, including but not limited to students, temporary workers, tourists, and businessmen will be able to use this currency by registering for the time that they are in the country. Their temporary unit will expire upon date expected to leave.

The current invention will work as follows. First, it must connect to the server and read its own identification code, first checking the balance in the account. Second, to send, the user must punch in his or her secret code, much like the Personal Identification Numbers used at ATMs. The sender then enters the amount that he wishes to send. The recipient instantly receives an alert, to which he may accept only by punching in his own secret code, and pushing a button to “accept”. The funds are transferred instantly.

Additionally, credit ratings will be available at the touch of a button, as well as the amount of loans and money left available in credit cards. This will help reduce bankruptcy, as each user will be constantly monitored as to his or her spending habits and ability to repay loans.

What is claimed is:

1. A small, portable, electronic device, used to transfer funds between two users, that will replace various all forms of currency including but not limited to: paper currency, credit cards and is connected to a law enforcement agency such as the government via the main server.
